(19) United States
(12) Patent Application Publication
(10) Pub. No.: US 2012/0224388 A1
(43) Pub. Date: Sep. 6, 2012

(54) BACKLIGHT SOURCE STRUCTURE HAVING SENSING FUNCTION AND PLATE BODY THEREOF

(75) Inventor: CHIH-HSIUNG LIN, New Taipei City (TW)

(73) Assignee: Era Optoelectronics Inc., New Taipei City (TW)

(21) Appl. No.: 13/244,408

(22) Filed: Sep. 24, 2011

(30) Foreign Application Priority Data
Mar. 1, 2011 (TW) 100106666

(51) Int. Cl. F21V 8/00

(52) U.S. Cl. 362/607

(57) ABSTRACT

A backlight source structure having a sensing function includes a plate body, an invisible light source and a light sensing plate, where the plate body includes a transparent plate, a partial reflection layer and a transparent material layer coupled to each other in sequence. The partial material layer can reflect invisible light partially, and allow invisible light to pass through partially and visible light to pass through fully. The invisible light projected in via the lateral end face of the plate body can be projected out from the front end face of the plate body, and the transparent plate. A position of the transparent plate on which a body touches can be detected by the light sensing plate.

### BACKGROUND OF THE INVENTION

1. Field of the Invention

The present invention relates to a backlight source, and more particularly to a backlight source structure having a sensing function, and a plate body thereof.

2. Description of Related Art

A conventional backlight source 1, as FIG. 1 shows, includes a plate 11 and a light source 12. Multiple regular or irregular microstructures 112 embossed on a rear end face 111 of the plate 11; when light 121 emitted from the light source 12 is projected in the plate 11 through a lateral end face 113 of the plate 11, and then on the microstructures 112, it will be scattered out of a front end face 114 of the plate 11, thereby forming uniform emergent light.

Furthermore, the conventional backlight source 1, as FIG. 2 shows, is used for obtaining a uniform planar light source without needing to consider the problem of the transmission of light 13 through the plate 11 such that it is an opaque structure; a viewer in front of the backlight source 1 cannot see the images behind the plate 11 because the microstructures 112 on a rear end face 111 of the plate 11 causes transmissive visible light 13 to be scattered too. Thereupon, the conventional backlight source 1 also has no sensing function.

Taiwan Publishing Patent No. 200950610 discloses a planar display, constituted by a touch-controlled liquid crystal display and a backlight source. The backlight source of the above-mentioned Taiwan publishing patent, as a general conventional backlight source, only provides light needed for injecting into the touch-controlled liquid crystal display without having transparent and sensing functions.

### SUMMARY OF THE INVENTION

To improve a conventional backlight source and a plate body thereof, the present invention is proposed.

The present invention is to provide a backlight source structure having a sensing function and a plate body thereof, where a rear end face of a transparent plate of the plate body is disposed with a plurality of concave-convex structures, the rear end face of the transparent plate is spread with a partial reflection layer, and the partial reflection layer can reflect invisible light partially and allows invisible light to pass through partially, but allows visible light to pass through fully; the rear end face of the partial reflection layer is combined, with a transparent material layer thereby filling and levelling up the plurality of concave-convex structures, allowing the transparent plate, the partial reflection layer, and the transparent material layer to be transparent to visible light; a light sensing plate is propped against the transparent material layer, capable of detecting the position of the front end face of the transparent plate on which a body touch, thereby achieving a sensing function.

Another object of the present invention is to provide a backlight source structure having a sensing function and a plate body thereof, where the above-mentioned light sensing plate is a thin film transistor-liquid crystal display (TFT-LCD) with light, sensing elements, allowing a viewer in front of the plate body to see the images displayed by the TFT-LCD, and utilizing the light sensing elements in the TFT-LCD to allow the plate body to detect the position of the front end face of the transparent plate that a finger touches, thereby having also a sensing function.

### BRIEF DESCRIPTION OF THE DRAWINGS

The present invention can be more fully understood by reference to the following description and accompanying drawings, in which:

FIG. 1 is a schematic view of a conventional backlight source;

FIG. 2 is a schematic view of the scattering of transmissive visible light caused by a conventional backlight plate;

FIG. 3 is a perspective view, snowing a backlight source structure having a sensing function of the present invention while a finger touches it;

FIG. 4 is a cross sectional view, showing a backlight source structure having a sensing function of the present invention while a finger touches it;

FIG. 5 is a partly enlarged cross sectional view, showing a backlight source structure having a sensing function of the present invention while a finger touches it; and

FIG. 6 is a cross sectional view, showing a transparent material layer, a partial reflection layer and a transparent plate of the present invention while visible light passes through them.

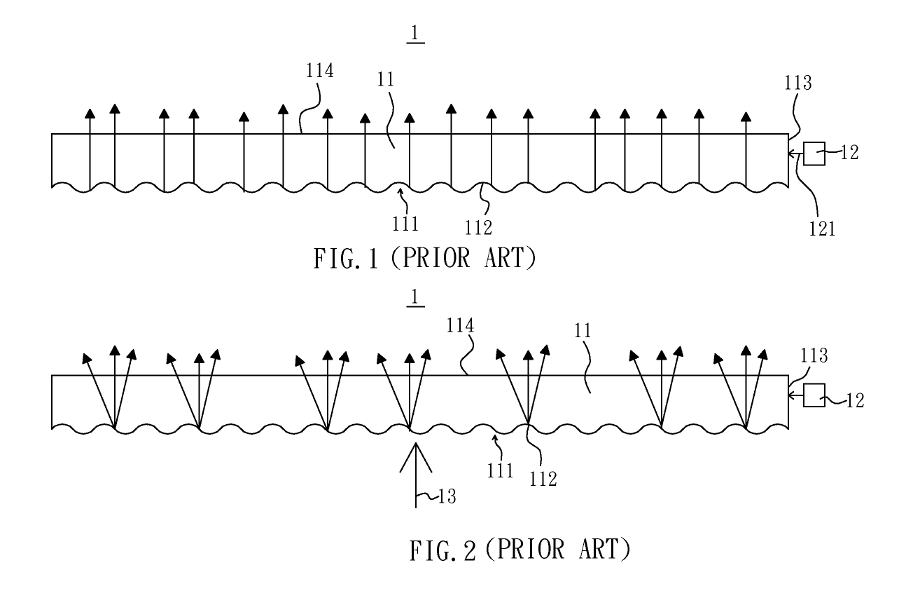

### DETAILED DESCRIPTION OF THE PREFERRED EMBODIMENTS

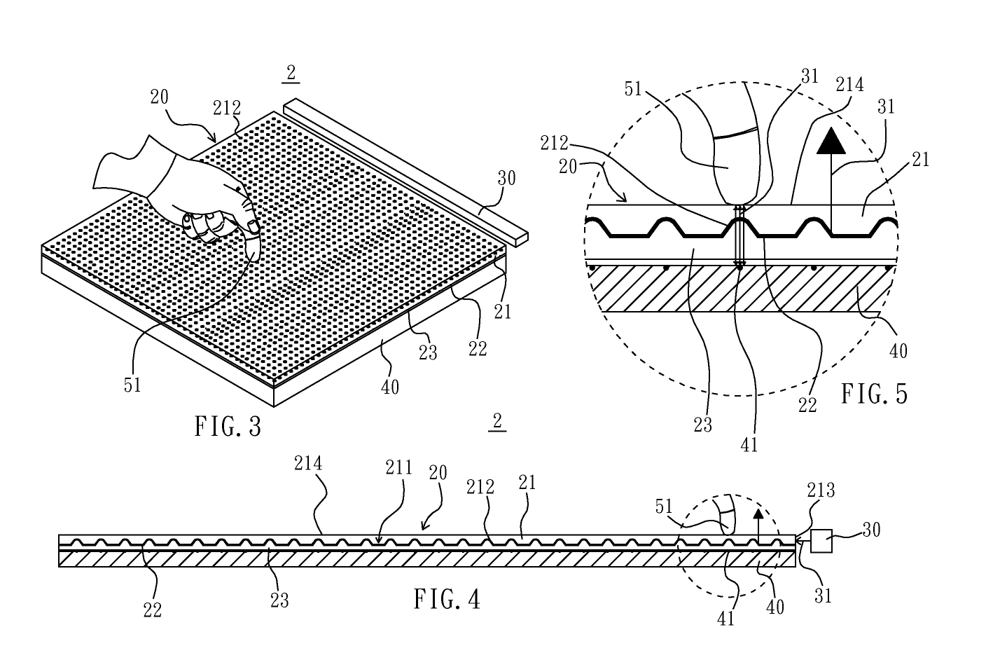

A backlight source structure 2 having a sensing function of the present invention, as FIGS. 3 and 4 show, includes a plate body 20, an invisible light source 30 and a light sensing plate 40, where the plate body 20 includes a transparent plate 21, a partial reflection layer 22 and a transparent material layer 23 coupled to one another in sequence.

Referring to FIG. 4, the transparent plate 21 has a rear end face 211, a lateral end face 213 and a front end face 214, where the rear end face 211 is disposed with a plurality of concave-convex structures 212. The material of the partial reflection layer 22 is a general conventional coating material, having the performance of reflecting invisible light partially, allowing invisible light to pass through partially and visible light to pass through fully. One end face of the partial reflection layer 22 is coupled to the rear end face 211, and to the plurality of concave-convex structures 212 too. Furthermore, another end face of the partial reflection layer 22 is coupled to the transparent material layer 23. The partial reflection layer 22 may be coupled to the rear end face 211 by means of coating, and the transparent material layer 23 may be coupled to the partial reflection layer 22 by means of spreading. The transparent layer 23 fills and levels up the plurality of the concave-convex structures 212 of the rear end face 211 of the transparent plate 21, thereby decreasing the refraction angle while visible light 32 passes through the partial reflection layer 22 and allowing the rear end face 211 of the transparent plate 21 to form a flat structure. The material of the transparent plate 21 may be a planar transparent acrylic plate or transparent glass plate. The material of the transparent material layer 23 may be a transparent resin having a refractive index approximately the same as the one of the transparent plate 21, such as UV resin or transparent silicone gel, where the refractive index difference between the transparent material layer 23 and transparent plate 21 is smaller than 0.5, for example, the refractive index of the transparent plate 21 is 0.1 larger or smaller than the refractive index of the transparent material layer 23, rather capable of decreasing the refraction angle while the light 32 passes through the partial reflection layer 22.

The light sensing plate 40 is propped against the transparent material layer 23, and may be a thin film transistor-liquid crystal display (TFT-LCD) with light sensing elements 41. The light sensing element 41 of the light sensing plate 40 can sense the invisible light 31 emitted from the invisible light source 30 and then passing directly through the transparent plate 21, the partial reflection layer 22 and the transparent material layer 23, but is not driven.

The concave-convex structure 212 may be prismatic, pyramidical, conic or the same, having a reflection face facing the invisible light source 30, capable of reflecting the invisible light 31 emitted from the invisible light source 30 to the front end face 214 of the transparent plate 21 and projecting it Out through the front end face 214 of the transparent plate 21, thereby forming a planar invisible light source.

Referring to FIG. 5, when a body 51 such as a finger, touches the front end face 214 of the transparent plate 21 to block the invisible light 31, causing the invisible light 31 to be reflected into the transparent plate 21 and then pass through the partial reflection layer 22 and the transparent material layer 23 to project to one light sensing element 41 corresponding to the position on which the body 51 touches among the plurality of light sensing elements 41 of the light sensing plate 40 to drive the light sensing element 41 corresponding to the position on which the body 51 touches; the position of the transparent plate 21 on which the body 51 touches can be known by which light sensing element 41 of the light sensing plate 40 sensing stronger invisible light and then driven, as such, it provides the plate body 20 with a sensing capability.

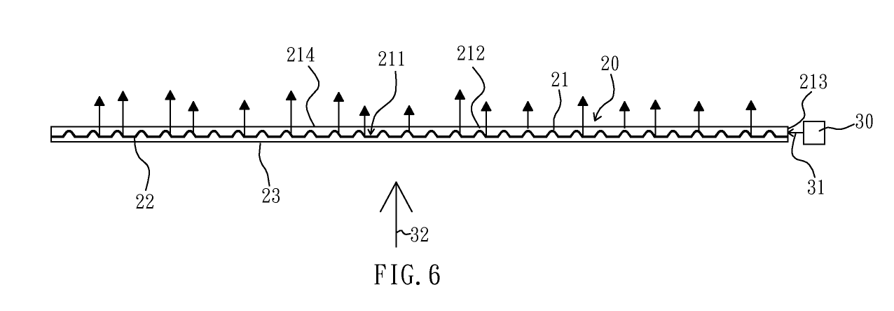

Visible light 32, as FIG. 6 shows, can pass through transparent material layer 23, partial reflection layer 22 and transparent plate 21, still allowing a viewer positioning in front of the front end face 214 to see the images behind the transparent material layer 23 clearly, and not to be influenced by the concave-convex structures 212 and the partial reflection layer 22; the viewer almost cannot see the concave-convex structures 212 and the partial reflection layer 22.

Referring to FIG. 4 again, the backlight source structure 2 having a sensing function of the present invention can change the direction of the invisible light 31 emitted from the invisible light (such as infrared light, or ultraviolet light) source 30 through the reflection of the plurality of concave-convex structures 212 and the partial reflection layer 22 while it is projected in via the lateral end face 213 of the transparent plate 21, causing the invisible light 31 to be projected out through the front end face 214 of the transparent plate 21. Visible light, in the meantime, can pass through the transparent material layer 23, the partial reflection layer 22 and the transparent plate 21, allowing a viewer positioning in front of the front end face 214 of the transparent plate 21 to see the images behind the transparent material layer 23 clearly such that the viewer positioning in front of the front end face 214 can see the images displayed by the light sensing plate 40 clearly, for example, the images display by a TFT-LCD. The invisible light blocked by the body 51 and reflected into the transparent plate 21 can pass through the partial reflection layer 22 and the transparent material layer 23 to project to the light sensing element 41 corresponding to the position on which the body 51 touches among the plurality of light sensing elements 41 of the light sensing plate 40, causing the light sensing element 41 corresponding to the position on which the body 51 touches to sense stronger invisible light and was driven consequently such that the position of the transparent plate 21 on which the body 51 touches can be detected, as such, it can achieve a sensibility capability.

The structures of a backlight source structure having a sensing function and a plate body thereof is simple. The invisible light projected into the lateral end face of the plate body can be projected uniformly out through the front end face of the plate body, and the visible light can pass through the transparent material layer, the partial reflection layer and the transparent plate, allowing a viewer positioning in front of the plate body to see the images displayed by a TFT-LCD clearly, and the backlight source having a sensing function to detect the position of the front end face of the transparent plate on which a finger (body) touches by means of the light sensing elements in the light sensing plate (TFT-LCD), as such, the present invention has a sensing capability, thereby enhancing the practical functions of the backlight source.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A backlight source structure having a sensing function, comprising:
an invisible light source;
a light sensing plate, disposed with a plurality of light sensing elements; and
a plate body, comprising:
a transparent plate, having a rear end face, a lateral end face and a front end face, said rear end face is disposed with a plurality of concave-convex structures;
a partial reflection layer, having a function of reflecting invisible light partially, and allowing invisible light to pass through partially and visible light to pass through fully; and
a transparent material layer;
wherein said transparent plate, said partial reflection plate and said transparent material layer are coupled to each other in sequence, and said partial reflection layer is also coupled to said plurality of concave-convex structures, said transparent material layer fills and levels up said plurality of concave-convex structures of said rear end face of said transparent plate, thereby decreasing a refraction angle while visible light passes through said partial reflection layer; said light sensing plate is propped against said transparent material layer; said invisible light source is adjacent to said lateral end face of said transparent plate;
wherein a direction of invisible light emitted from said invisible light source is changed through a reflection of said plurality of concave-convex structures and said partial reflection layer while said invisible, light is projected in via said lateral end face of said transparent plate, causing said invisible light to be projected out from said front end face of said transparent plate; visible light passes through said transparent material layer, said partial reflection layer and said transparent plate in sequence; said invisible light blocked by a body and reflected into the transparent plate passes through said partial reflection layer and said transparent material layer to project to one light sensing element corresponding to a position on which said body touches among said plurality of light sensing elements of said light sensing plate when said body touches said front end face of said transparent plate, causing said light sensing element corresponding to said position on which said body touches to sense stronger invisible light and be driven consequently such that said position of said transparent plate on which said body touches is detected, as such, a sensibility capability is achieved.

2. The backlight source structure having a sensing function according to claim 1, wherein said light sensing plate is a thin film transistor liquid crystal display (TFT-LCD) with said light sensing elements, allowing a viewer positioning in front of said plate body to see images displayed on said thin film transistor liquid crystal display (TFT-LCD), and utilizing said light sensing element of said thin film transistor liquid crystal display (TFT-LCD) to detect a position of said transparent plate on which a body touches.

3. The backlight source structure having a sensing function according to claim 2, wherein a refractive index difference between said transparent material layer and said transparent plate is smaller than 0.5; said transparent plate is planar, and the material of said transparent material layer is one of transparent resin and transparent silicon gel.

4. The backlight source structure having a sensing function according to claim 3, wherein said concave-convex structure is one of prismatic, pyramidical and conic.

5. The backlight source structure having a sensing function according to claim 4, wherein said transparent plate is one of a transparent acrylic plate and a transparent glass plate; the material of said transparent material layer is an UV curable resin; said partial reflection on layer is coupled to said rear end face by means of coating, and said transparent material layer is coupled to said partial reflection layer by means of spreading; said invisible light source is an infrared light source.

6. A plate body, comprising:
a transparent plate, having a rear end face, a lateral end face and a front end face, said rear end face is disposed with a plurality of concave-convex structures;
a partial reflection layer, having a function of reflecting invisible light partially, and allowing invisible light to pass through partly and visible light to pass through fully; and
a transparent material layer;
wherein said transparent plate, said partial reflection plate and said transparent material layer are coupled to each other in sequence, and said partial reflection layer is also coupled to said plurality of concave-convex structures, said transparent material layer fills and levels up said plurality of concave-convex structures of said rear end face of said transparent plate, thereby decreasing a refraction angle while visible light passes through said partial reflection layer;
wherein a direction of invisible light emitted from the invisible light source is changed through a reflection of said plurality of concave-convex structures and said partial reflection layer while said invisible light is prol acted in via said lateral end face of said transparent plate, causing said invisible light to be projected out from said front end face of said transparent plate;
visible light passes through said transparent material, said partial reflection layer and said transparent plate in sequence; said invisible light blocked by a body and reflected into the transparent plate passes through said partial reflection layer and said transparent material layer to project to one light sensing element corresponding to a position on which said body touches among a plurality of light sensing elements of said light sensing plate when said body touches said front end face of said transparent plate, causing said light sensing element corresponding to said position on which said body touches to sense stronger invisible light and be driven consequently such that said position of said transparent plate on which said body touches is detected.

7. The plate body according to claim 6, wherein the backlight source structure having a sensing function according to claim 6, wherein a refractive index difference between said transparent material layer and said transparent plate is smaller than 0.5.

8. The plate body according to claim 7, wherein said transparent plate is planar, and the material of said transparent material layer is one of transparent resin and transparent silicon gel.

9. The plate body according to claim 8, wherein said concave-convex structure is one of prismatic, pyramidical and conic.

10. The plate body according to claim 9, wherein said transparent plate is one of a transparent acrylic plate and a transparent glass plate; the material of said transparent material layer is an UV curable resin; said partial reflection layer is coupled to said rear end face by means of coating, and said transparent material layer is coupled to said partial reflection layer by means of spreading; said invisible light source is an infrared-light light source.
